(19) United States
(12) Patent Application Publication
(10) Pub. No.: US 2016/0090782 A1
(43) Pub. Date: Mar. 31, 2016

(54) Floating Ladder

(71) Applicant: Paul J. C. Kwoka, Redmond, WA (US)

(72) Inventor: Paul J. C. Kwoka, Redmond, WA (US)

(21) Appl. No.: 14/498,720

(22) Filed: Sep. 26, 2014

(51) Int. Cl. E06C 1/12; B63B 27/14; E06C 1/02

(52) U.S. Cl. CPC E06C 1/12; E06C 1/02; B63B 27/14

(57) ABSTRACT

The instant application discloses, among other things, a Floating Ladder. In one embodiment, it may comprise a ladder capable of attaching to any object, such as a fixed or floating dock, for instance. Floating Ladder may include a floatation device at its base, which may allow the ladder to ascend above the surface of the water when the ladder is not in use. This may prevent the Floating Ladder from sustaining damage from any natural or artificial substance, object, or organism, which may render the ladder unsafe or unusable, for instance. In another embodiment, Floating Ladder may include multiple sections to allow a user to telescope the ladder further into the water when necessary.

### FIELD

This disclosure relates generally to a Floating Ladder.

### BACKGROUND

Many people of all ages enjoy swimming in natural or artificial bodies of water such as oceans, rivers, lakes, and swimming pools. Getting out of the water often poses hardship for even the most experienced swimmers. For example, even a strong, nimble adult may have difficulty pulling himself onto a surface, such as a dock, without assistance. Devices such as ladders have traditionally been used to facilitate exit from the water. However, ladders often must be tilted, lowered, or unfolded into the water, which may be inconvenient and difficult, especially for a weak or lone swimmer, for example. Ladders, such as those installed in or near water, remain susceptible to damage from natural and artificial substances such as chlorine, or living organisms such as barnacles or tube worms, for example, which may render the ladders dangerous or unusable.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a Floating Ladder. In one embodiment, it may comprise a ladder capable of attaching to any object, such as a fixed or floating dock, for example. Floating Ladder may include an object, such as a floatation device, at its base, which may use buoyancy to lift the ladder above or near the surface of the water when the ladder is not in use. This may prevent the Floating Ladder from becoming damaged by any substance, object, condition, or organism, for example, which may render the ladder unsafe. Floating Ladder may be configured to be easily accessible and fully operational from the water by a weak or lone swimmer, such as a child, for example, thus eliminating or minimizing the need for assembly or for deployment by another person.

In another embodiment, Floating Ladder may include multiple sections to allow a user to telescope the ladder further into the water when necessary. In yet another embodiment, Floating Ladder may retract into a protective casing to shield the ladder from rain, snow, wind, or any natural or artificial elements, for example. A person skilled in the art would understand that Floating Ladder may be made from any material such as metal, plastic, rubber, carbon fiber, fiberglass, or wood. Floating Ladder may also be made in various colors, shapes, and sizes.

Many of the attendant features may be more readily appreciated as they become better understood by reference to the following detailed description considered in connection with the attached drawings.

### BRIEF DESCRIPTION OF THE DRAWINGS

FIG. 1 illustrates a Floating Ladder according to one embodiment.

FIG. 2 illustrates an exemplary user ascending onto Floating Ladder according to one embodiment.

FIG. 3 illustrates an exemplary user preparing to descend from Floating Ladder and back onto land, according to one embodiment.

FIG. 4 illustrates a flow diagram of a method utilizing Floating Ladder according to one embodiment.

### DETAILED DESCRIPTION

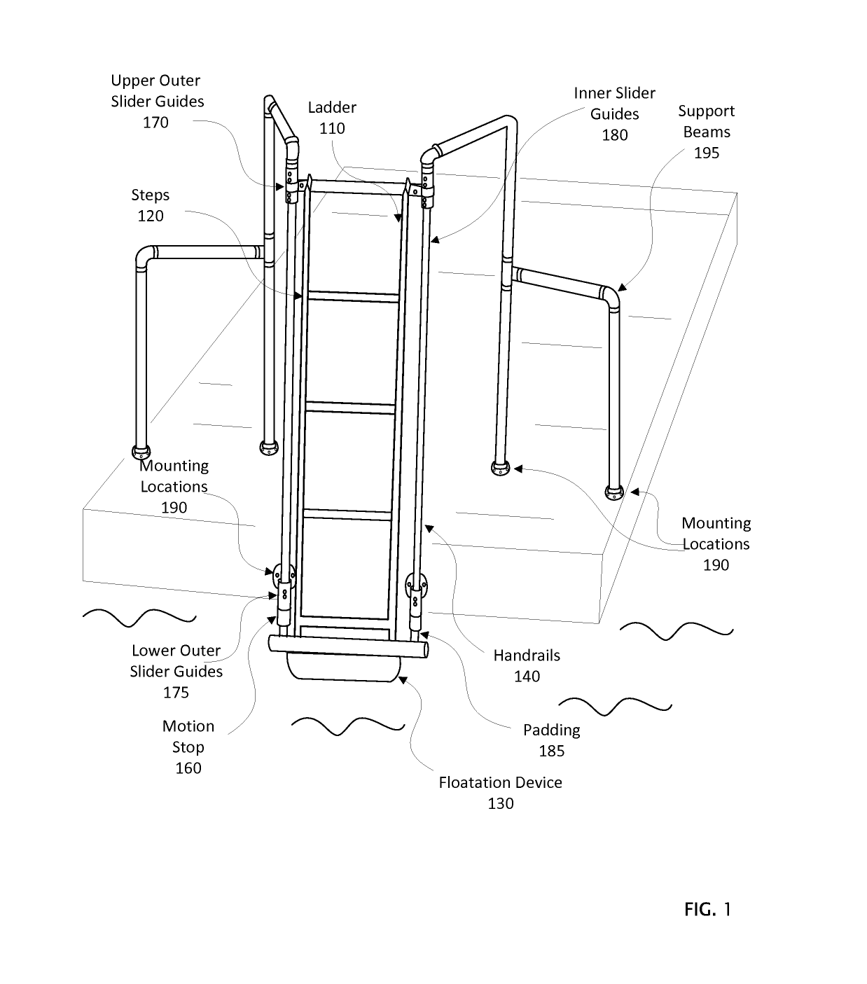

FIG. 1 illustrates a Floating Ladder according to one embodiment. In this embodiment, Floating Ladder may comprise an elongated structure such as Ladder 110, capable of attaching to any object, such as a fixed or floating dock, for example. It may also attach to a ship or swimming pool, or to any surface or object adjacent to a natural or artificial body of water, for example. Floating Ladder may include a plurality of Steps 120, rungs, or bars, for example, which may allow a user to easily climb from the water onto the structure. Instead of resting partially or fully inside the water, like many traditionally installed ladders, Floating Ladder may rest entirely above the water's surface when not in use. This may be made possible by the inclusion of an object such as Flotation Device 130 at its base, for example, which may use buoyancy to lift Ladder 110 above the surface of the water when the ladder is not in use. For example, a swimmer may use her body weight to pull down Ladder 110 enough to bring her feet onto Steps 120, causing the ladder to descend into the water. The swimmer may grasp Handrails 140 and continue pushing down onto Ladder 110 using her legs and feet, for example, until Ladder 110 comes to a rest upon hitting any motion stop, such as an upward motion stop or a bottom Motion Stop 160, for example. The swimmer may then step off of Ladder 110 and onto any object or surface, such as a boat or dock, for example. Because of the buoyancy of Floatation Device 130, Ladder 110 may automatically retract upwards and out of the water when the swimmer steps off and the ladder is not in use, resting into place by an upward or downward Motion Stop 160. This may prevent Ladder 110 from fouling with natural or artificial substances, objects, conditions, or organisms, such as chemicals, seaweed, barnacles, or tube worms, for example, which may damage Floating Ladder or interfere with its usability. Upper Outer Slider Guides 170, Lower Outer Slide Guides 175, and Inner Slider Guides 180 may provide stability and direction as Ladder 110 ascends and descends. Floatation Device 130 may include Padding 185 to cushion the impact against the base of a motion stop such as Motion Stop 160, for example, and prevent damage upon the ladder's ascent.

Floating Ladder may attach to any object or surface at Mounting Locations 190 or any other site, by any attachment means such as bolts or an adhesive such as cement, for instance. Floating Ladder may be supported by Support Beams 195, which may be assembled in any configuration. Floating Ladder may be available for use all of the time; thus, it may not be necessary to put it into operation before use and stowed after use, for example. Floating Ladder may be configured to be easily accessible and fully operational from the water by a weak or lone swimmer, such as a child, for example, thus eliminating or minimizing the need for assembly or for deployment by another person. The base of Floating Ladder 110 may also be self-adjusting to rest just above the surface of the water regardless of changing relative positions between the water surface and the ladder mounting structure, due to tides and wave action, for example.

In another embodiment, Floating Ladder may include multiple sections to allow a user to telescope the ladder further into the water when necessary. In yet another embodiment, Floating Ladder may automatically retract into a protective casing to shield the ladder from rain, snow, wind, or any natural or artificial elements, for example. A person skilled in the art would appreciate that Floating Ladder may be made from any material such as metal, plastic, rubber, carbon fiber, fiberglass, and wood. Floating Ladder may also be made in various colors, shapes, and sizes.

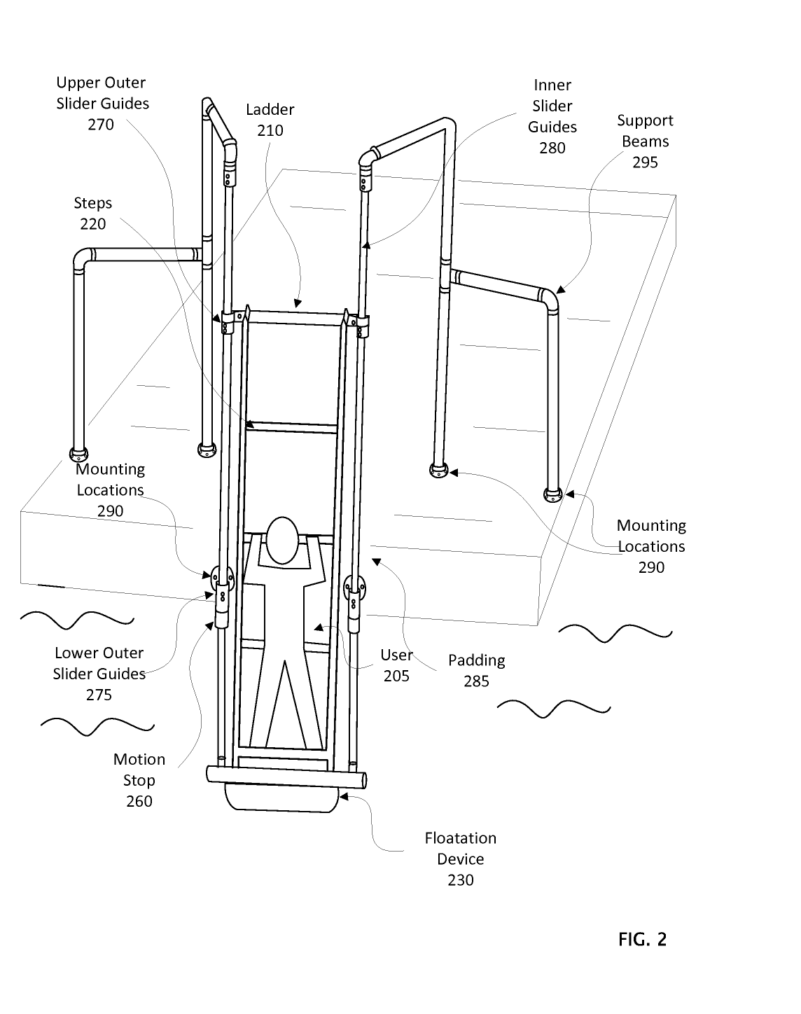

FIG. 2 illustrates User 205 ascending onto Floating Ladder according to one embodiment. In this example, User 205, who may be any living person or animal of any age, weight, size, and strength, is shown climbing onto Ladder 210 by stepping onto Steps 220 while pulling down on Steps 220. The weight of User 205 may cause Ladder 210 to descend into the water as User 205 climbs upward toward an object or surface such as a dock, for example. Ladder 210 may rest into place upon hitting an upward or downward motion stop such as Motion Stop 260, for example. Floating Ladder may include Floatation Device 230 at its base, or any other location, which may use buoyancy to pull Ladder 210 upward when it the ladder is not in use. Upon its ascent, Ladder 210 may stop upon hitting a motion stop such as Motion Stop 260, for example, or when Floatation Device 230 reaches equilibrium. Upper Outer Slider Guides 270, Lower Outer Slide Guides 275, and Inner Slider Guides 280 may provide stability and direction as Ladder 210 moves up or down. Floatation Device 230 may include Padding 285 to cushion the impact against the base of a motion stop such as Motion Stop 260 and prevent damage upon the ladder's ascent. Floating Ladder may attach to any object or surface at Mounting Locations 290 or any other site, by any attachment means. Floating Ladder may be supported by Support Beams 295, which may comprise any arrangement.

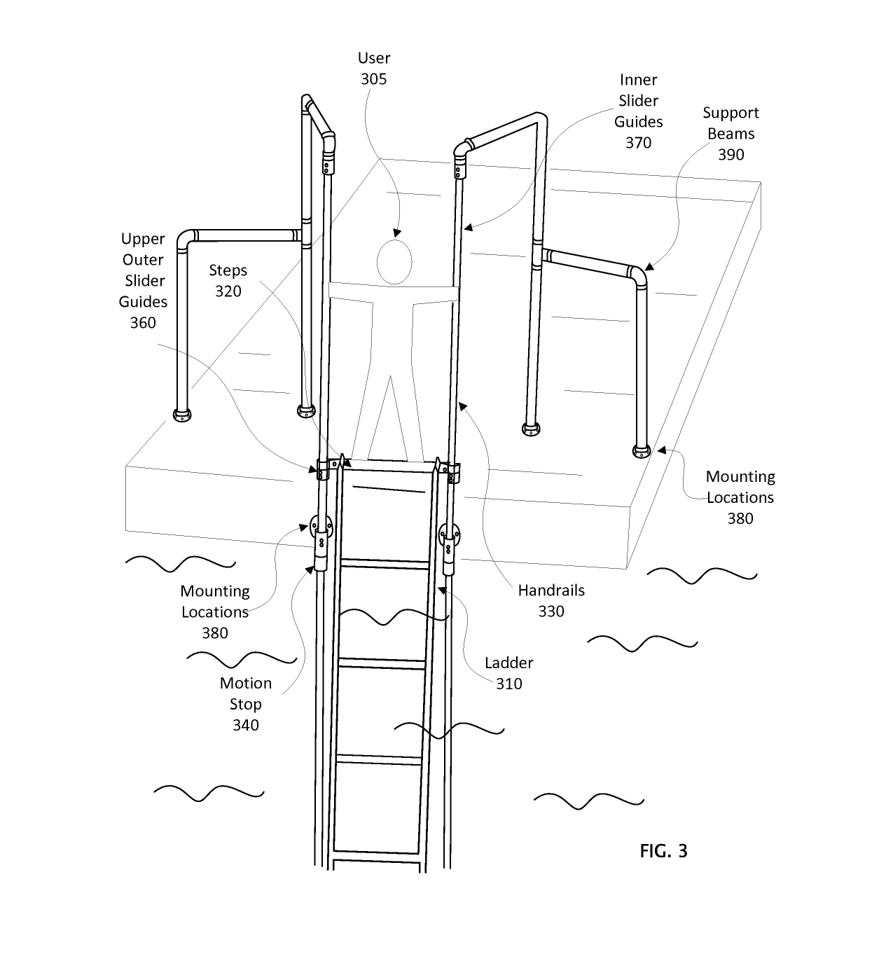

FIG. 3 illustrates User 305 preparing to transition from Floating Ladder back onto land, according to one embodiment. Here, User 305 is shown standing on a higher rung of Steps 320 of Ladder 310 while grasping Handrails 330. User 305 may push down on Steps 320 using her hands, legs, and feet it until Ladder 310 rests into position by an upward or downward motion stop such as Motion Stop 340, for example, or the ladder rests on the bottom of the body of water in relatively shallow situations. User 305 may step off of Ladder 310 and onto any object or surface, such as a ship, dock, or an adjacent piece of land, for example. The buoyancy of Floatation Device, which may be depicted as submerged in this illustration, may cause Ladder 310 to automatically retract upwards and out of the water once User 305 steps off of Ladder 310. Ladder 310 may stop upon touching a motion stop such as Motion Stop 340, for example, or when the Floatation Device reaches equilibrium. Upper Outer Slider Guides 360 and Inner Slider Guides 370 may provide stability and direction as Ladder 310 ascends and descends. Floating Ladder may attach to any object or surface at Mounting Locations 380 or any other site, by any attachment means. Floating Ladder may be supported by Support Beams 390, which may be assembled in any configuration.

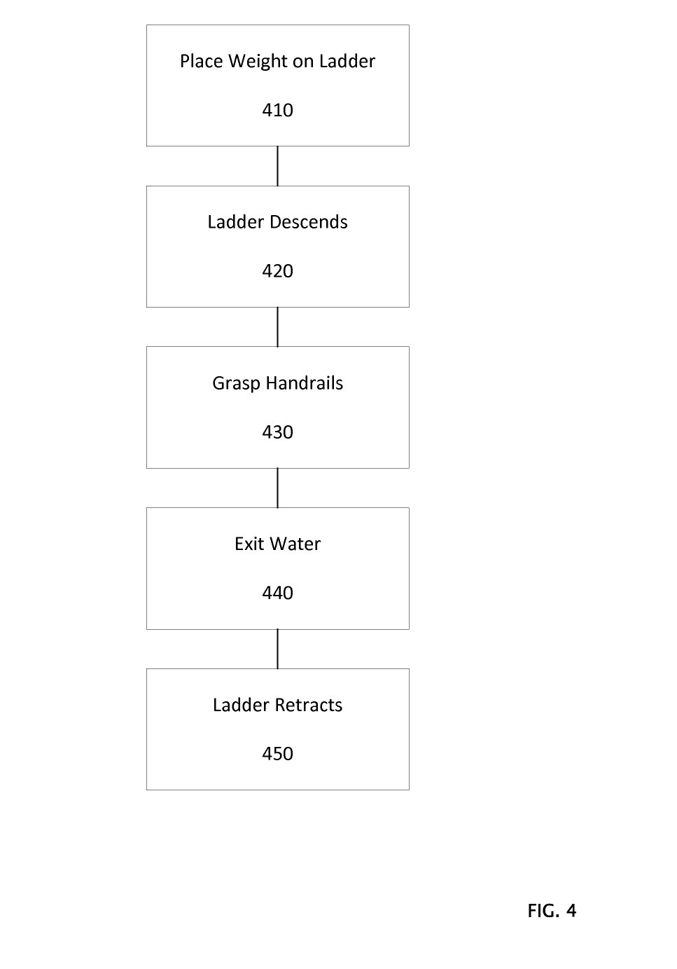

FIG. 4 illustrates a flow diagram of a method utilizing Floating Ladder according to one embodiment. At Place Weight on Ladder 410, a user, such as a swimmer, may grab onto Floating Ladder and pull or push downward using her hands, legs, or feet, for example. At Ladder Descends 420, weight of the user's body may cause Floating Ladder to move downward into the water until it rests into place by a motion stop. At Grasp Handrails 430, the user may hold onto the handrails or steps of Floating Ladder to facilitate her ability to climb up any remaining steps of Floating Ladder and pull herself upward, out of the water. At Exit Water 440, the user may fully extricate herself from the water and step onto any object or surface such as a boat, shore, or dock, for example. At Ladder Retracts 450, the floatation device at the base, for example, of Floating Ladder, may cause the ladder to ascend upward until it reaches a motion stop or the floatation device at the base reaches equilibrium and assumes its resting position. A method utilizing Floating Ladder may also provide for flexibility to clean up or streamline the design with professional materials and manufacturing processes.

A person skilled in the art will appreciate that the steps comprising a method utilizing a Floating Ladder may be performed in a different order, modified, or removed without departing from the spirit and scope of the invention. Moreover, steps may be added to the above-described logic and still conform to the described embodiments. Further, steps described herein may occur sequentially, or certain steps may take place simultaneously.

1. A floating ladder, comprising:
a ladder, the ladder having a plurality of steps;
a base, the base including a buoyant object;
at least one handrail;
at least one support beam, the support beam having at least one attachment means.

2. The floating ladder of claim 1, wherein the ladder is made of any material from the list containing metal, plastic, rubber, carbon fiber, fiberglass, and wood

3. The floating ladder of claim 1 wherein the ladder includes multiple sections configured to allow for the extension of the ladder.

4. The floating ladder of claim 1, wherein the support beam has any attachment means from the list containing nails, bolts, suction cups, cement, and adhesives.

5. The floating ladder of claim 1, wherein the ladder retracts into a protective casing.

6. A motorized ladder, comprising:
a ladder, the ladder comprising a plurality of steps and a bottom;
a motor coupled to the ladder, configured to raise and lower the ladder;
at least one handrail;
at least one support beam, the support beam having at least one attachment means;
a water-activated switch functionally coupled to the motor, configured to activate the motor appropriately to keep the bottom of the ladder at a surface of a body of water.

8. A retractable ladder, comprising:
a ladder, the ladder having a plurality of steps, the ladder comprising multiple sections, the multiple sections configured to adjust the effective length of the ladder;
at least one handrail;
at least one support beam, the support beam having at least one attachment means.

9. The retractable water ladder of claim 9, wherein a spring provides an upward force.

10. The retractable water ladder of claim 9, wherein a stretch cord provides an upward force.

11. The retractable water ladder of claim 9, wherein a counterweight provides an upward force.
